(19) United States
(12) Patent Application Publication
(10) Pub. No.: US 2026/0189258 A1
(43) Pub. Date: Jul. 2, 2026

(54) APPARATUS, SYSTEM AND METHOD FOR PROCESSING RADIO FREQUENCY SIGNALS

(71) Applicant: Nokia Solutions and Networks Oy, Espoo (FI)

(72) Inventors: Dirk WIEGNER, Schwaikheim (DE); Andreas WICH, Stuttart (DE); Thales STEDILE-RIBEIRO, Neu-Ulm (DE)

(73) Assignee: Nokia Solutions and Networks Oy, Espoo (FI)

(21) Appl. No.: 19/131,066

(22) PCT Filed: Nov. 24, 2022
(86) PCT No.: PCT/EP2022/083178

§ 371 Date: May 19, 2025

(51) Int. Cl. H04B 1/401; H04B 1/04; H04B 1/48

(52) U.S. Cl. CPC H04B 1/401; H04B 1/48; H04B 2001/0408

(57) ABSTRACT

An apparatus for processing radio frequency signals, comprising a first amplifier stage, a second amplifier stage, a first switch, a second switch, and an output processing stage, wherein the first switch is configured to selectively provide a first signal or a second signal to the first amplifier stage, wherein the second switch is configured to selectively provide an output signal of the first amplifier stage to the second amplifier stage or to the output processing stage, wherein the second amplifier stage comprises an amplifier configured to amplify the output signal as provided by the second switch to the second amplifier stage to obtain an amplified signal, wherein the second amplifier stage comprises a coupler configured to provide a portion of the amplified signal to the output processing stage.

### FIELD OF THE DISCLOSURE

Various exemplary embodiments relate to an apparatus for processing radio frequency signals.

Further exemplary embodiments relate to a system for processing radio frequency signals.

Further exemplary embodiments relate to a method for processing radio frequency signals.

### BACKGROUND

Apparatus for processing radio frequency, RF, signals may e.g. be used in transceiver devices, e.g. for wireless communication systems.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some exemplary embodiments relate to an apparatus for processing radio frequency signals, comprising a first amplifier stage, a second amplifier stage, a first switch, a second switch, and an output processing stage, wherein the first switch is configured to selectively provide a first signal or a second signal to the first amplifier stage, wherein the second switch is configured to selectively provide an output signal of the first amplifier stage to the second amplifier stage or to the output processing stage, wherein the second amplifier stage comprises an amplifier configured to amplify the output signal as provided by the second switch to the second amplifier stage to obtain an amplified signal, wherein the second amplifier stage comprises a coupler configured to provide a portion of the amplified signal to the output processing stage.

In some exemplary embodiments, the apparatus can e.g. be used for a transmitter/receiver, e.g. transceiver, device, wherein, for example, the first amplifier stage may e.g. be used both for processing signals to be transmitted by the transceiver and for processing signals received by the transceiver, e.g. in a time division duplexed, TDD, manner. In other words, in some exemplary embodiments, at least some components of the apparatus according to the embodiments may e.g. be commonly used, e.g. in a TDD-type fashion, for processing signals to be transmitted by the transceiver and for processing signals received by the transceiver.

In some exemplary embodiments, the apparatus can e.g. be used for a transceiver for a component of a wireless communication system, e.g. for a base station and/or a terminal device of a wireless communication system. As an example, when using the apparatus according to the embodiments for a transceiver of a base station, the apparatus e.g. enables to process downlink signals and uplink signals associated with the base station.

In some exemplary embodiments, the coupler of the second amplifier stage may e.g. be used to provide a feedback signal, e.g. for at least one of: a) assessing a signal quality of the amplified signal, b) performing linearization, e.g. using a digital predistortion technique at a digital processing stage.

In some exemplary embodiments, as the coupler can e.g. directly be provided at the output of the amplifier of the second amplifier stage, a particularly precise feedback mechanism is enabled, e.g. as compared to some conventional approaches where a feedback signal is e.g. obtained from another device or stage of the conventional system, where possibly an increased interference is experienced, and hence e.g. a linearization with reduced precision can be attained. In other words, in some exemplary embodiments, a, for example significantly, reduced Signal-to-Interference-Ratio (SIR) level of the feedback signal as provided by the coupler can be attained using the approach according to exemplary embodiments.

In some exemplary embodiments, the coupler is a directional coupler.

In some exemplary embodiments, the output processing stage comprises a third switch which is configured to selectively provide a) the output signal of the first amplifier stage as provided by the second switch to the third switch or b) the portion of the amplified signal to an output of the third switch. In some exemplary embodiments this may e.g. enable to choose which of the abovementioned signals are output, e.g. to another device, e.g. a downconversion stage, e.g. for processing received signals, or a linearization stage which is configured to perform linearization processing based on the portion of the amplified signal.

In some exemplary embodiments, the operation of at least one of the first, second and third switch can e.g. be controlled by applying a respective control signal to the respective switch. In some exemplary embodiments, similar observations may also apply to further switches which may be provided according to further exemplary embodiments.

In some exemplary embodiments, the amplifier of the second amplifier stage is a power amplifier.

In some exemplary embodiments, the first amplifier stage comprises at least one of the following: a) a first amplifier, for example first low noise amplifier (LNA), b) a filter, e.g. band-pass filter, c) an attenuator, for example a controllable attenuator an attenuation of which may be control by applying a respective control signal to the controllable attenuator, d) a second amplifier, for example second low noise amplifier, e) a phase shifter, for example controllable phase shifter, which applies a predetermined phase shift to a signal based on a respective control signal, f) a controllable, e.g. variable, amplifier, e.g. variable gain amplifier. Note that in some exemplary embodiments, e.g. a variable gain amplifier may be used instead alternatively or additionally to a, for example controllable, attenuator.

In some exemplary embodiments, the apparatus, for example in a first operating mode, is configured to control the first switch to provide the first signal to the first amplifier stage, and to control the second switch to provide the output signal of the first amplifier stage to the second amplifier stage. In some exemplary embodiments, this configuration can be used for processing the first signal subsequently by the first amplifier stage and then by the second amplifier stage. In some exemplary embodiments, such processing can e.g. be used for amplifying the first signal for a transmission, e.g. using at least one antenna, which, in some exemplary embodiments, may e.g. be coupled (e.g., either directly, or indirectly, e.g. by at least one of a circulator or a switch or the like) to an output of the second amplifier stage.

In some exemplary embodiments, the apparatus, e.g. in the first operating mode, is configured to control the third switch to provide the portion of the amplified signal to an output of the third switch, whereby a feedback signal can be provided, e.g. for linearization processing.

In some exemplary embodiments, the first operating mode may e.g. be used for processing signals in a transmit direction of e.g. a transceiver comprising the apparatus according to the embodiments.

In some exemplary embodiments, the apparatus, e.g. in a second operating mode different from the first operating mode, is configured to control the first switch to provide the second signal to the first amplifier stage, to control the second switch to provide the output signal of the first amplifier stage to the third switch. In some exemplary embodiments, this configuration may e.g. be used for amplifying a signal, e.g. the second signal.

In some exemplary embodiments, the second signal may e.g. be a signal that has been received by at least one antenna or a signal that is derived from (e.g., by some form of processing, e.g. signal processing) a signal that has been received by at least one antenna. In other words, in some exemplary embodiments, the second operating mode may e.g. be used for processing signals in a receive direction of e.g. a transceiver comprising the apparatus according to the embodiments.

In some exemplary embodiments, the apparatus, e.g. in the second operating mode, is configured to control the third switch to provide the output signal of the first amplifier stage to the output of the third switch.

In some exemplary embodiments, the apparatus, e.g. in the second operating mode, is configured to deactivate the amplifier of the second amplifier stage, thus e.g. increasing an energy efficiency, e.g. of a transceiver operating in a TDD-type mode comprising the apparatus according to the embodiments.

In some exemplary embodiments, the apparatus comprises at least one antenna configured to a) transmit a signal provided by the second amplifier stage and/or to b) receive the second signal and provide the second signal (or a signal derived from the second signal) to the first switch.

In some exemplary embodiments, the apparatus comprises at least one of the following elements for coupling at least one of the second amplifier stage or the first switch with the at least one antenna: a) a circulator, b) a switch, c) a filter, e.g. band-pass filter.

In some exemplary embodiments, the apparatus comprises a fourth switch for selectively coupling at least one component of the apparatus with a termination resistor, thus e.g. reducing or avoiding signal reflections or interference, e.g. during a feedback signal processing.

In some exemplary embodiments, the apparatus comprises a third amplifier stage, the third amplifier stage comprising an amplifier configured to amplify a signal provided to an input port of the third amplifier stage, and a coupler configured to provide a portion of an amplified signal obtained by the amplifier to the third switch.

In some exemplary embodiments, the amplifier of the third amplifier stage is a power amplifier.

In some exemplary embodiments, an output port of the second switch is coupled with respective input ports of the second amplifier stage and the third amplifier stage by means of a coupling device, thus e.g. enabling to provide respective portions of the output signal of the first amplifier stage to the second amplifier stage and the third amplifier stage.

In some exemplary embodiments, the coupling device comprises at least one of: a) a switch, b) a diplexer.

In some exemplary embodiments, the first amplifier stage is configured to process multiband radio frequency signals comprising at least a first frequency band and a second frequency band, wherein the second amplifier stage is configured to process a single frequency band of the at least first frequency band or second frequency band.

In some embodiments, the first frequency band and the second frequency band are non-contiguous, i.e. have a non-vanishing frequency spacing between each other. In some embodiments, the frequency spacing may e.g. comprise 10 MHz or more. In some embodiments, the frequency spacing may e.g. comprise 100 MHz or more, e.g. depending on a processing bandwidth of the first amplifier stage.

In some embodiments, the multiband radio frequency signals comprise more than two frequency bands, e.g. three or more frequency bands, wherein at least two of the three or more frequency bands may e.g. be non-contiguous.

In some exemplary embodiments, e.g. when the multiband radio frequency signals comprise more than two frequency bands, e.g. three or more frequency bands, either a further frequency band specific power amplifier stage can be added or one of the two amplifier stages may be designed to simultaneously amplify e.g. two of the e.g. three frequency bands. In some exemplary embodiments, a decision which variant is used can e.g. be done based on the frequency spacing(s) of the respective frequency bands.

In some exemplary embodiments, the apparatus comprises a combiner, for example diplexer, a switch for selectively providing the portion of the amplified signal associated with the second amplifier stage or a further signal to a first input port of the combiner, and a switch for selectively providing the portion of the amplified signal associated with the third amplifier stage or a further signal to a second input port of the combiner.

In some exemplary embodiments, the apparatus comprises a combiner, for example diplexer, for combining the portion of the amplified signal associated with the second amplifier stage with the portion of the amplified signal associated with the third amplifier stage.

In some exemplary embodiments, at least one of the second amplifier stage and the third amplifier stage comprises bypass switches to selectively bypass a respective amplifier of the second amplifier stage and the third amplifier stage.

Further exemplary embodiments relate to an apparatus for processing radio frequency signals, comprising first amplifier means, second amplifier means, first switch means configured to selectively provide a first signal or a second signal to the first amplifier means, second switch means configured to selectively provide an output signal of the first amplifier means to the second amplifier means or to output processing means, wherein the second amplifier means are configured to amplify the output signal as provided by the second switch means to the second amplifier means to obtain an amplified signal, wherein the second amplifier means are further configured to provide a portion of the amplified signal to the output processing means.

Further exemplary embodiments relate to a system for processing radio frequency signals, comprising a first apparatus according to the embodiments and at least one further apparatus according to the embodiments, wherein a common output processing stage is provided for the first apparatus and the at least one further apparatus. In some exemplary embodiments, by providing the first apparatus and the at least one further apparatus, higher transmit powers can be attained when using the system for providing signal(s) to be transmitted.

In some exemplary embodiments, the common output processing stage comprises a first combiner configured to combine respective output signals of the first amplifier stage of the first apparatus and the at least one further apparatus.

In some exemplary embodiments, the system comprises a splitter configured to provide a respective first signal to a respective first amplifier stage of the first apparatus and the at least one further apparatus. This way, respective portions of a same first signal, e.g. input signal, can be provided to the respective first amplifier stages of the system.

In some exemplary embodiments, the system comprises a first switch for selectively providing the portion of the amplified signal of the first apparatus or of the at least one further apparatus at an output of the first switch.

In some exemplary embodiments, the system comprises a second switch for selectively providing an output signal of the common output processing stage or an output signal of the first switch at an output of the second switch.

In some exemplary embodiments, the system comprises a second combiner configured to combine respective output signals of the couplers of the first apparatus and the at least one further apparatus.

In some exemplary embodiments, the system comprises a third switch for selectively providing an output signal of the common output processing stage or an output signal of the second combiner at an output of the third switch.

Further exemplary embodiments relate to a method of operating an apparatus for processing radio frequency signals, the apparatus comprising a first amplifier stage, a second amplifier stage, a first switch, a second switch, and an output processing stage, the method comprising: selectively providing, by means of the first switch, a first signal or a second signal to the first amplifier stage, selectively providing, by means of the second switch, an output signal of the first amplifier stage to the second amplifier stage or to the output processing stage, wherein the second amplifier stage comprises an amplifier configured to amplify the output signal as provided by the second switch to the second amplifier stage to obtain an amplified signal, wherein the second amplifier stage comprises a coupler configured to provide a portion of the amplified signal to the output processing stage.

In some exemplary embodiments, the output processing stage comprises a third switch, wherein the method comprises: selectively providing, by means of the third switch, a) the output signal of the first amplifier stage as provided by the second switch to the third switch or b) the portion of the amplified signal at an output of the third switch.

In some exemplary embodiments, the method comprises: controlling the first switch to provide the first signal to the first amplifier stage, controlling the second switch to provide the output signal of the first amplifier stage to the second amplifier stage.

In some exemplary embodiments, the method comprises: controlling the third switch to provide the portion of the amplified signal to an output of the third switch.

In some exemplary embodiments, the method comprises: controlling the first switch to provide the second signal to the first amplifier stage, controlling the second switch to provide the output signal of the first amplifier stage to the output processing stage.

In some exemplary embodiments, the output processing stage comprises a third switch, and the method comprises: controlling the third switch to provide the output signal of the first amplifier stage to an output of the third switch.

In some exemplary embodiments, the method comprises: deactivating the amplifier of the second amplifier stage.

In some exemplary embodiments, the method comprises: processing, by means of the first amplifier stage, multiband radio frequency signals comprising at least a first frequency band and a second frequency band.

In some exemplary embodiments, the method comprises: processing, by the second amplifier stage, a first single frequency band of the at least first frequency band or second frequency band.

In some exemplary embodiments, the method comprises: processing, by a third amplifier stage, a second single frequency band of the at least first frequency band and second frequency band, wherein the second single frequency band is different from the first single frequency band.

### BRIEF DESCRIPTION OF THE FIGURES

FIG. 1 schematically depicts a simplified block diagram according to exemplary embodiments,

FIG. 2 schematically depicts a simplified block diagram according to exemplary embodiments,

FIG. 3A schematically depicts a simplified block diagram according to exemplary embodiments,

FIG. 3B schematically depicts a simplified block diagram according to exemplary embodiments,

FIG. 4 schematically depicts a simplified state diagram according to exemplary embodiments,

FIG. 5 schematically depicts a simplified block diagram according to exemplary embodiments,

FIG. 6 schematically depicts a simplified block diagram according to exemplary embodiments,

FIG. 7 schematically depicts a simplified block diagram according to exemplary embodiments,

FIG. 8 schematically depicts a simplified block diagram according to exemplary embodiments,

FIG. 9 schematically depicts a simplified frequency diagram according to exemplary embodiments,

FIG. 10 schematically depicts a simplified block diagram according to exemplary embodiments,

FIG. 11 schematically depicts a simplified block diagram according to exemplary embodiments,

FIG. 12 schematically depicts a simplified block diagram according to exemplary embodiments,

FIG. 13 schematically depicts a simplified block diagram according to exemplary embodiments,

FIG. 14 schematically depicts a simplified block diagram according to exemplary embodiments,

FIG. 15 schematically depicts a simplified block diagram according to exemplary embodiments,

FIG. 16 schematically depicts a simplified block diagram according to exemplary embodiments,

FIG. 17 schematically depicts a simplified block diagram according to exemplary embodiments,

FIG. 18 schematically depicts a simplified block diagram according to exemplary embodiments,

FIG. 19 schematically depicts a simplified block diagram according to exemplary embodiments,

FIG. 20A schematically depicts a simplified flow-chart according to exemplary embodiments,

FIG. 20B schematically depicts a simplified flow-chart according to exemplary embodiments,

FIG. 20C schematically depicts a simplified flow-chart according to exemplary embodiments,

FIG. 20D schematically depicts a simplified flow-chart according to exemplary embodiments,

FIG. 21 schematically depicts a simplified flow-chart according to exemplary embodiments,

FIG. 22 schematically depicts a simplified flow-chart according to exemplary embodiments,

FIG. 23 schematically depicts aspects of use according to exemplary embodiments,

FIG. 24 schematically depicts a simplified block diagram according to exemplary embodiments.

### DESCRIPTION OF SOME EXEMPLARY EMBODIMENTS

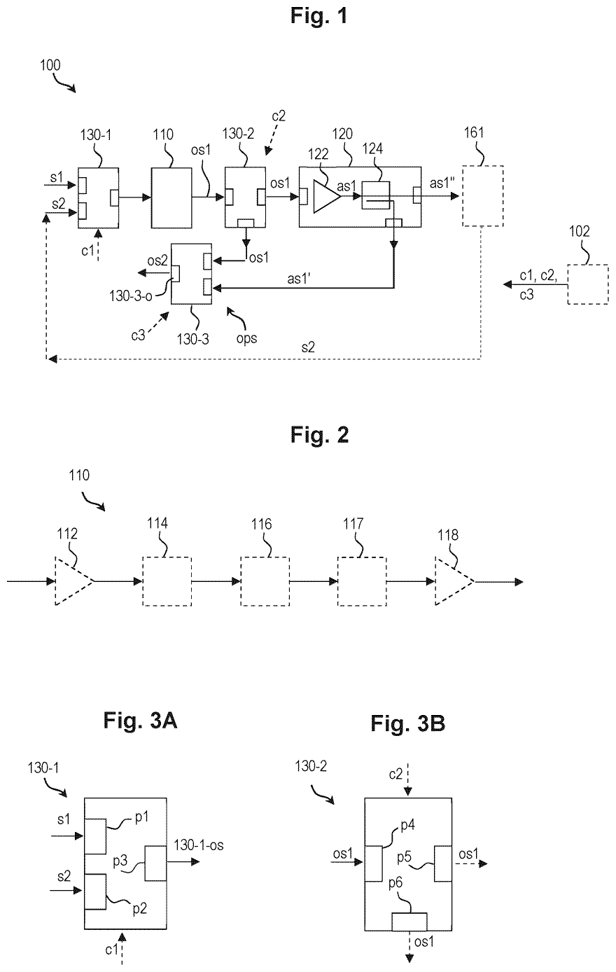

Some exemplary embodiments, FIG. 1, relate to an apparatus 100 for processing radio frequency signals, comprising a first amplifier stage 110, a second amplifier stage 120, a first switch 130-1, a second switch 130-2, and an output processing stage ops, wherein the first switch 130-1 is configured to selectively provide a first signal s1 or a second signal s2 to the first amplifier stage 110. The second switch 130-2 is configured to selectively provide an output signal os1 of the first amplifier stage 110 to the second amplifier stage 120 or to the output processing stage ops. The second amplifier stage 120 comprises an amplifier 122 configured to amplify the output signal os1 as provided by the second switch 130-2 to the second amplifier stage 120 to obtain an amplified signal as1, wherein the second amplifier stage 120 comprises a coupler 124 configured to provide a portion as1′ of the amplified signal as1 to the output processing stage ops. In some exemplary embodiments, another portion as1″ of the amplified signal as1 may be provided, e.g. to at least one antenna 161.

In some exemplary embodiments, the apparatus 100 can e.g. be used for a transmitter/receiver, e.g. transceiver, device, wherein, for example, the first amplifier stage 110 may e.g. be used both for processing signals s1 to be transmitted by the transceiver and for processing signals s2 received by the transceiver, e.g. in a time division duplexed, TDD, manner. In other words, in some exemplary embodiments, at least some components of the apparatus 100 according to the embodiments may e.g. be commonly used, e.g. in a TDD-type fashion, for processing signals to be transmitted by the transceiver and for processing signals received by the transceiver.

In some exemplary embodiments, the coupler 124 of the second amplifier stage 120 may e.g. be used to provide a feedback signal as1′, e.g. for at least one of: a) assessing a signal quality of the amplified signal as1, b) performing linearization, e.g. using a, for example digital, predistortion technique at a, for example digital, processing stage (not shown).

In some exemplary embodiments, as the coupler 124 can e.g. directly be provided at the output of the amplifier 122 of the second amplifier stage 120, a particularly precise feedback mechanism is enabled, e.g. as compared to some conventional approaches where a feedback signal is e.g. obtained from another device or stage of the conventional system, where possibly an increased interference is experienced, and hence e.g. a linearization with reduced precision can be attained. In other words, in some exemplary embodiments, a, for example significantly, reduced Signal-to-Interference-Ratio (SIR) level of the feedback signal as1′ as provided by the coupler 124 can be attained using the approach according to exemplary embodiments.

In some exemplary embodiments, the coupler 124 is a directional coupler.

In some exemplary embodiments, FIG. 1, the output processing stage ops comprises a third switch 130-3 which is configured to selectively provide a) the output signal os1 of the first amplifier stage 110 as provided by the second switch 130-2 to the third switch 130-3 or b) the portion as1′ of the amplified signal as1 at an output 130-3-o of the third switch 130-3, e.g. as an output signal os2. In some exemplary embodiments this may e.g. enable to choose which of the abovementioned signals os1, as1′ are output, e.g. to another device (not shown), e.g. a downconversion stage, e.g. for processing received signals, or a linearization stage which is configured to perform linearization processing based on the portion as1′ of the amplified signal as1.

In some exemplary embodiments, FIG. 1, the operation of at least one of the first, second and third switch 130-1, 130-2, 130-3 can e.g. be controlled by applying a respective control signal c1, c2, c3 to the respective switch. In some exemplary embodiments, similar observations may also apply to further switches which may be provided according to further exemplary embodiments.

In some exemplary embodiments, a control unit 102 may be provided which may be configured to provide at least one of the control signals c1, c2, c3.

In some exemplary embodiments, FIG. 1, the amplifier 122 of the second amplifier stage 120 is a power amplifier.

In some exemplary embodiments, FIG. 2, the first amplifier stage 110 comprises at least one of the following: a) a first amplifier, for example first low noise amplifier (LNA), 112 b) a filter, e.g. band-pass filter, 114, c) an attenuator 116, for example a controllable attenuator an attenuation of which may be control by applying a respective control signal (not shown) to the controllable attenuator (and/or a variable gain amplifier), d) a second amplifier, for example second low noise amplifier, 118, e) a phase shifter 117, for example controllable phase shifter, which applies a predetermined phase shift to a signal based on a respective control signal (not shown).

FIG. 3A schematically depicts a simplified block diagram of the first switch 130-1. The first switch 130-1 comprises a first port p1, e.g. input port, e.g. for receiving the first signal s1, a second port p2, e.g. input port, e.g. for receiving the second signal s2, and a third port p3, e.g. output port, for providing the first signal s1 or the second signal s2 as an output signal 130-1-os, e.g. to the first amplifier stage 110 (FIG. 1).

In some exemplary embodiments, the third switch 130-3 of FIG. 1 comprises a similar or identical configuration as the first switch 130-1 as exemplarily depicted by FIG. 3A.

FIG. 3B schematically depicts a simplified block diagram of the second switch 130-2. The second switch 130-2 comprises a first port p4, e.g. input port, e.g. for receiving the output signal os1, a second port p5, e.g. output port, e.g. for providing the output signal os1, and a third port p6, e.g. output port, for providing the output signal os1. In other words, in some embodiments, using the third switch 130-3, the output signal os1 as provided by the first amplifier stage 110 may selectively be provided to either the second amplifier stage 120, e.g. via the output port p5, or to the output processing stage ops, e.g. third switch 130-3, e.g. via the output port p6.

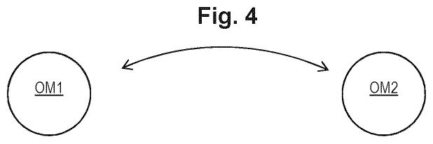

In some exemplary embodiments, FIG. 4, the apparatus 100 (FIG. 1), for example in a first operating mode OM1, is configured to control the first switch 130-1 to provide the first signal s1 to the first amplifier stage 110, and to control the second switch 130-2 to provide the output signal os1 of the first amplifier stage 110 to the second amplifier stage 120. In some exemplary embodiments, this configuration can be used for processing the first signal s1 subsequently by the first amplifier stage 110 and then by the second amplifier stage 120. In some exemplary embodiments, such processing can e.g. be used for amplifying the first signal s1 for a transmission, e.g. using at least one antenna 161 (FIG. 1), which, in some exemplary embodiments, may e.g. be coupled (e.g., either directly, or indirectly, e.g. by at least one of a circulator or a switch or the like) to an output of the second amplifier stage 120.

In some exemplary embodiments, FIGS. 1, 4, the apparatus 100, e.g. in the first operating mode OM1, is configured to control the third switch 130-3 to provide the portion as1′ of the amplified signal as1 to an output 130-3-o of the third switch 130-3, whereby e.g. a feedback signal can be provided, e.g. for linearization processing (not shown).

In some exemplary embodiments, FIG. 4, the first operating mode OM1 may e.g. be used for processing signals in a transmit direction of e.g. a transceiver comprising the apparatus 100 (FIG. 1) according to the embodiments.

In some exemplary embodiments, FIGS. 1, 4, the apparatus 100, e.g. in a second operating mode OM2 different from the first operating mode OM1, is configured to control the first switch 130-1 to provide the second signal s2 to the first amplifier stage 110, to control the second switch 130-2 to provide the output signal os1 of the first amplifier stage 110 to the third switch 130-3. In some exemplary embodiments, this configuration may e.g. be used for amplifying a signal, e.g. the second signal s2.

In some exemplary embodiments, the second signal s2 may e.g. be a signal that has been received by at least one antenna 161 (FIG. 1) or a signal that is derived from (e.g., by some form of processing, e.g. signal processing) a signal that has been received by at least one antenna 161. In other words, in some exemplary embodiments, the second operating mode OM2 may e.g. be used for processing signals in a receive direction of e.g. a transceiver comprising the apparatus 100 according to the embodiments.

In some exemplary embodiments, the apparatus 100, e.g. in the second operating mode OM2, is configured to control the third switch 130-3 to provide the output signal os1 of the first amplifier stage 110 to the output 130-3-o of the third switch 130-3.

In some exemplary embodiments, FIGS. 1, 4, the apparatus 100, e.g. in the second operating mode OM2, is configured to deactivate the amplifier 122 of the second amplifier stage 120, thus e.g. increasing an energy efficiency, e.g. of a transceiver operating in a TDD-type mode comprising the apparatus 100 according to the embodiments.

In some exemplary embodiments, FIG. 1, the apparatus 100 comprises at least one antenna 161 configured to a) transmit a signal as1″ provided by the second amplifier stage 120 and/or to b) receive the second signal s2 and provide the second signal s2 or a signal derived from the second signal s2 to the first switch 130-1.

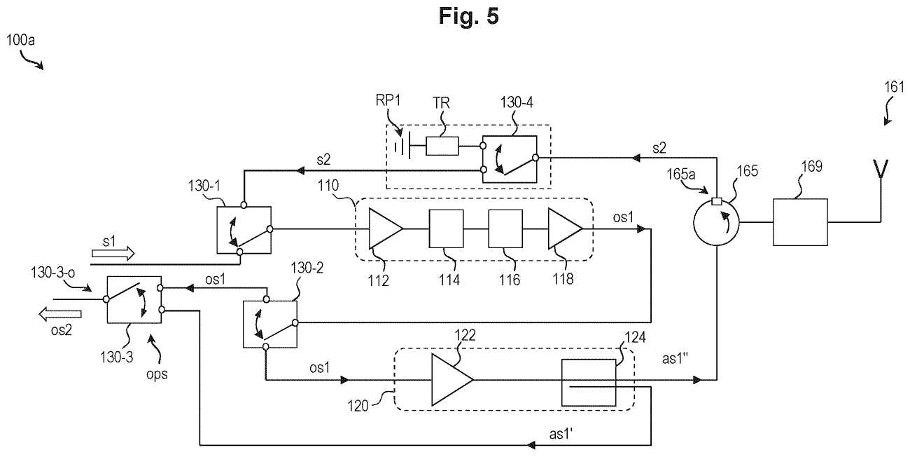

FIG. 5 schematically depicts an apparatus 100a according to further exemplary embodiments. Similar to the apparatus 100 of FIG. 1, the apparatus 100a of FIG. 5 comprises the switches 130-1, 130-2, 130-3 and the amplifier stages 110, 120.

In some exemplary embodiments, the apparatus 100a comprises at least one of the following elements for coupling at least one of the second amplifier stage 120 or the first switch 130-1 with the at least one antenna 161: a) a circulator 165, b) a switch (not shown in FIG. 5), c) a filter 169, e.g. band-pass filter.

As can be seen from FIG. 5, in some embodiments, a signal received by the antenna 161 is output at the output port 165a of the circulator 165 and provided as the second signal s2 to the first switch 130-1, presently via a further, optional fourth switch 130-4 explained further below. As can also be seen from FIG. 5, in a transmit configuration, the first signal s1 can be amplified by the amplifier stages 110, 120 and a portion as1″ of the so amplified signal can be fed via the circulator 165 to the at least one antenna 161, e.g. via the band-pass filter 169.

In some exemplary embodiments, FIG. 5, the apparatus 100a comprises the fourth switch 130-4 for selectively coupling at least one component of the apparatus 100a, presently the output port 165a of the circulator 165, with a termination resistor TR, thus e.g. reducing or avoiding signal reflections or interference, e.g. during a feedback signal processing. In some embodiments, the termination resistor TR is connected to an electric reference potential RP1, such as e.g. a ground potential.

In some embodiments, e.g. for a receive operation, the fourth switch 130-4 is controlled such (e.g., using a control signal, e.g. similar to elements c1, c2, c3 of FIG. 1) that the output port 165a of the circulator 165 is connected via the fourth switch 130-4 to the input port of the first switch 130-1.

In some embodiments, e.g. for a transmit operation, the fourth switch 130-4 is controlled such that the output port 165a of the circulator 165 is connected via the termination resistor TR1 to the ground potential RP1, thus reducing or avoiding interference from the circulator 165 and hence ensuring a comparatively high SIR of the signal portion as1′ that can e.g. be used for linearization.

In other words, in some exemplary embodiments, e.g. by the proposed coupler 124 at the output of the amplifier 122, interfering signals overlying to the wanted feedback signal as1′ which can e.g. be used for linearization in some exemplary embodiments can be reduced or prevented, and, for example, no additional effort on linearization, e.g. using (digital) predistortion algorithms, is required to get rid of unwanted interfering signals.

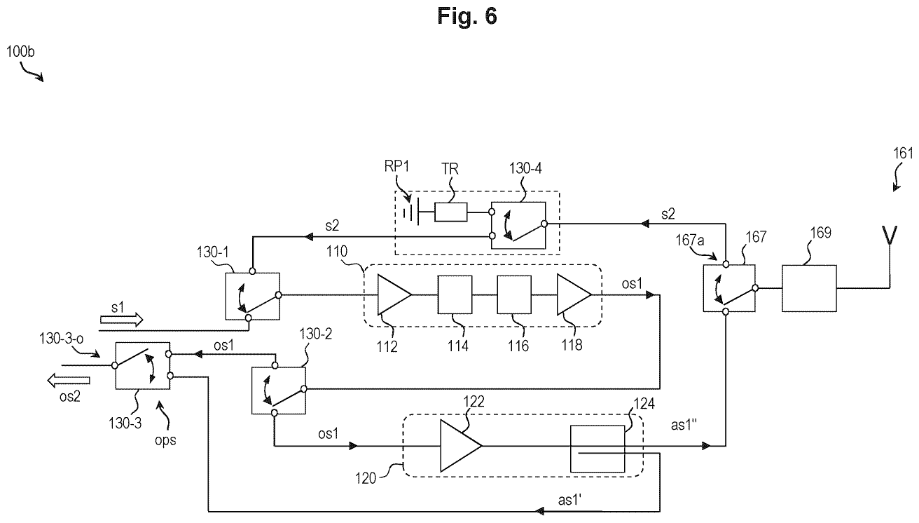

FIG. 6 schematically depicts an apparatus 100b according to further exemplary embodiments. Similar to the apparatus 100a of FIG. 5, the apparatus 100b of FIG. 6 comprises switches 130-1, 130-2, 130-3, 130-4 and amplifier stages 110, 120.

For coupling the components 120, 130-1, 161, the apparatus 100b comprises a switch 167, which is configured to selectively couple the components 130-1 (e.g., via the switch 130-4), 161 (e.g., via the filter 169) with the second amplifier stage 120. In some exemplary embodiments, the port 167a of the switch 167 can selectively be terminated using the fourth switch 130-4.

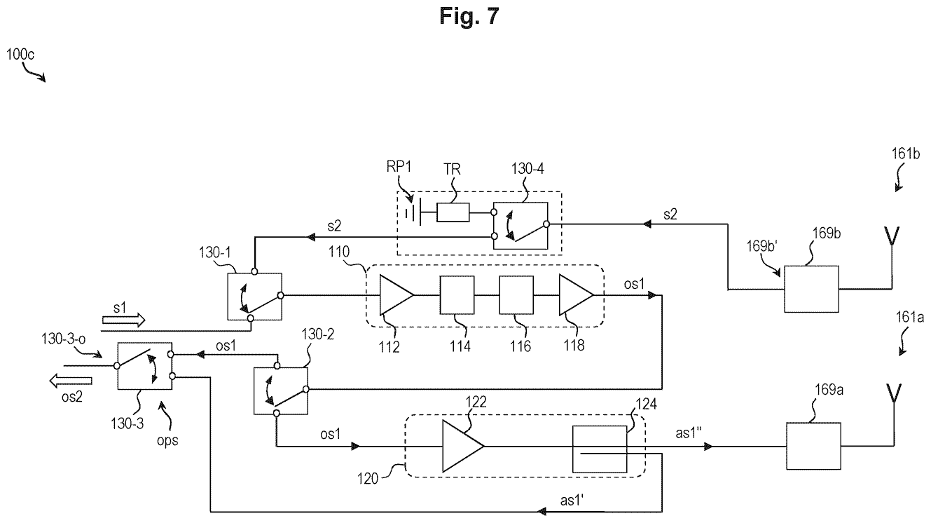

FIG. 7 schematically depicts an apparatus 100c according to further exemplary embodiments. Similar to the apparatus 100a of FIG. 5, the apparatus 100b of FIG. 7 comprises switches 130-1, 130-2, 130-3, 130-4 and amplifier stages 110, 120. In some exemplary embodiments, the apparatus 100c comprises two antennas or antenna systems 161a, 161b and respective associated antenna filters 169a, 169b, e.g. band-pass filters. In some exemplary embodiments, the antenna or antenna system 161a may e.g. be used for transmitting signals, e.g. in a downlink direction (e.g., if using the apparatus 100c for a base station of a wireless communications system). In some exemplary embodiments, the antenna or antenna system 161b may e.g. be used for receiving signals, e.g. in an uplink direction (e.g., if using the apparatus 100c for a base station of a wireless communications system).

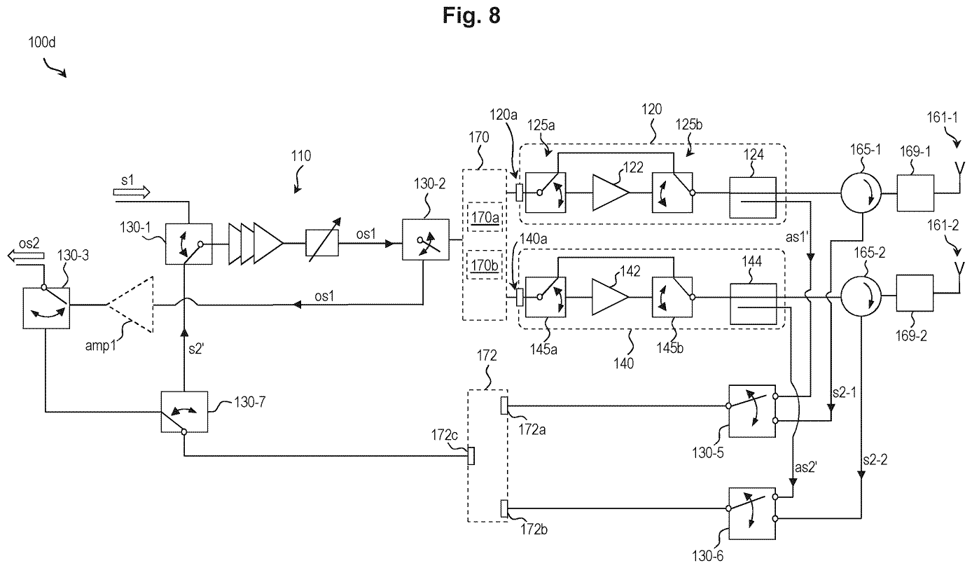

In some exemplary embodiments, FIG. 8, the apparatus 100d comprises a third amplifier stage 140, the third amplifier stage 140 comprising an amplifier 142 configured to amplify a signal provided to an input port 140a of the third amplifier stage 140, and a coupler 144 configured to provide a portion as2′ of an amplified signal obtained by the amplifier 142 to the third switch 130-3.

In some exemplary embodiments, FIG. 8, the amplifier 142 of the third amplifier stage 140 is a power amplifier, e.g. similar to the amplifier 122 of the second amplifier stage 120.

In some exemplary embodiments, FIG. 8, an output port of the second switch 130-2 is coupled with respective input ports 120a, 140a of the second amplifier stage 120 and the third amplifier stage 140 by means of a coupling device 170, thus e.g. enabling to provide respective portions of the output signal os1 of the first amplifier stage 110 to the second amplifier stage 120 and the third amplifier stage 140.

In some exemplary embodiments, FIG. 8, the coupling device 170 comprises at least one of: a) a switch (e.g., for selectively providing the output signal os1 to one of the amplifier stages 120, 140), b) a diplexer (e.g., for providing respective signal portions, e.g. different frequency bands, to a respective one of the amplifier stages 120, 140).

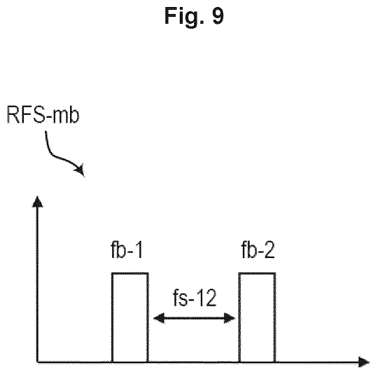

In some exemplary embodiments, FIGS. 8, 9, the first amplifier stage 120 is configured to process multiband radio frequency signals RFS-mb comprising at least a first frequency band fb-1 and a second frequency band fb-2, wherein the second amplifier stage 140 (FIG. 8) is configured to process a single frequency band fb-1 of the at least first frequency band fb-1 or second frequency band fb-2.

In some embodiments, the first frequency band fb-1 and the second frequency band fb-2 are non-contiguous, i.e. have a non-vanishing frequency spacing fs-12 between each other. In some embodiments, the frequency spacing fs-12 may e.g. comprise 10 MHz or more. In some embodiments, the frequency spacing fs-12 may e.g. comprise 100 MHz or more, e.g. depending on a processing bandwidth of the first amplifier stage 110, which in some exemplary embodiments may e.g. be configured to process at least two of the frequency bands fb-1, fb-2 of the multiband radio frequency signal RFS-mb.

In some embodiments, the multiband radio frequency signals RFS-mb comprise more than two frequency bands fb-1, fb-2, e.g. three or more frequency bands, wherein at least two of the three or more frequency bands may e.g. be non-contiguous.

In some exemplary embodiments, FIG. 8, the apparatus 100d comprises a combiner 172, for example diplexer, a switch 130-5 for selectively providing the portion as1′ of the amplified signal associated with the second amplifier stage 120 or a further signal s2-1 (e.g., from the antenna 161-1, e.g. via the circulator 165-1) to a first input port 172a of the combiner 172, and a switch 130-6 for selectively providing the portion as2′ of the amplified signal associated with the third amplifier stage 140 or a further signal s2-2 to a second input port 172b of the combiner 172.

In other words, in some exemplary embodiments, the apparatus 100d comprises a combiner, for example diplexer, for combining the portion as1′ of the amplified signal associated with the second amplifier stage 120 with the portion as2′ of the amplified signal associated with the third amplifier stage 140.

In some exemplary embodiments, FIG. 8, at least one of the second amplifier stage 120 and the third amplifier stage 140 comprises bypass switches 125a, 125b, 145a, 145b to selectively bypass a respective amplifier 122, 142 of the second amplifier stage 120 and the third amplifier stage 140.

The exemplary configuration of FIG. 8 is an example of how a feedback coupling can be provided with a multiband architecture, e.g. for an RF transceiver. As an example, feedback signals as1′, as2′ associated with different frequencies or frequency bands fb-1 and fb-2 (which may e.g. be non-contiguous) can be provided, e.g. tapped, e.g. by the couplers, e.g. directional couplers, 124, 144.

In some exemplary embodiments, e.g. during a downlink transmit signal processing operation, wherein the first signal s1 is provided by the first switch 130-1 to the first amplifier stage 110 and wherein the output signal os1 of the first amplifier stage 110 is provided by means of the coupling device 170 to the amplifier stages 120, 140, feedback signals as1′, as2′ may be provided by the couplers 124, 144, and may e.g. be provided via the switches 130-5, 130-6 and the combiner 172 and a further, optional switch 130-7 and the third switch 130-3, e.g. as an output signal os2, which, in some exemplary embodiments, can e.g. be used for linearization, e.g. after a downconversion (not shown).

In some exemplary embodiments, e.g. during an uplink or received signal processing operation, signals s2-1, s2-2 as received by the antennas 161-1, 161-2 are provided via the circulators 165-1, 165-2, the switches 130-5, 130-6, the combiner 172 to an output port 172c of the combiner 172.

In some exemplary embodiments, the so combined received signals s2-1, s2-2 can either be directly output, e.g. provided to a further processing stage (e.g., downconversion, not shown), e.g. via the switches 130-7, 130-3, or the combined received signals s2-1, s2-2 can be provided by the switch 130-7 and the first switch 130-1 to the first amplifier stage 110, e.g. for LNA amplification processing, and the output signal os1 may be provided to the third switch 130-3 for output as output signal os2.

In some exemplary embodiments, an optional amplifier amp1 may be provided between the switches 130-2, 130-3, whereby further amplification can be attained.

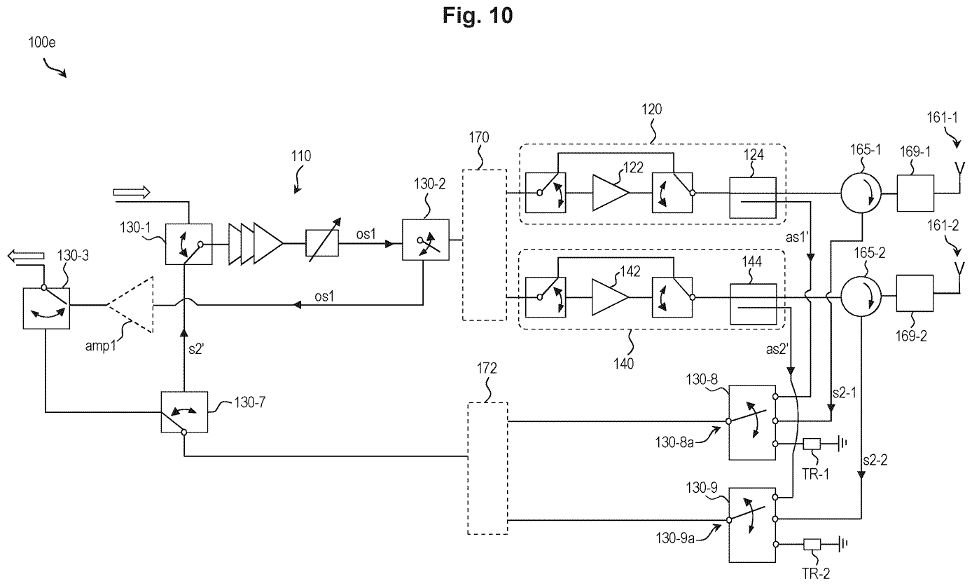

FIG. 10 schematically depicts an apparatus 100e according to further exemplary embodiments, which is similar to the apparatus 100d of FIG. 8. However, instead of the switches 130-5, 130-6 as depicted by FIG. 8, the apparatus 100e of FIG. 10 comprises switches 130-8, 130-9, which are configured to selectively connect their respective outputs 130-8a, 130-9a with respective termination resistors TR-1, TR-2. This way, in some exemplary embodiments, it can be selected to provide only one of the presently for example two feedback signals as1′, as2′ to the third switch 130-3, e.g. via the combiner 172 and switch 130-7. This way, an individual feedback of a single one of the multiple frequency bands fb-1, fb-2 as processed by the amplifier stages 120, 140 may be selected in some exemplary embodiments.

In some exemplary embodiments, in addition to the termination resistor connection, the switches 130-8, 130-9 are similar to the switches 130-5, 130-6 of FIG. 8, e.g. enabling to selective provide the signal as1′ or s2-1 (switch 130-8) or the signal as2′ or s2-2 (switch 130-9) to the combiner 172. Thus, in some exemplary embodiments, e.g. a selective calibration or selective linearization, e.g. if parasitic coupling of the circulator is used, can be achieved.

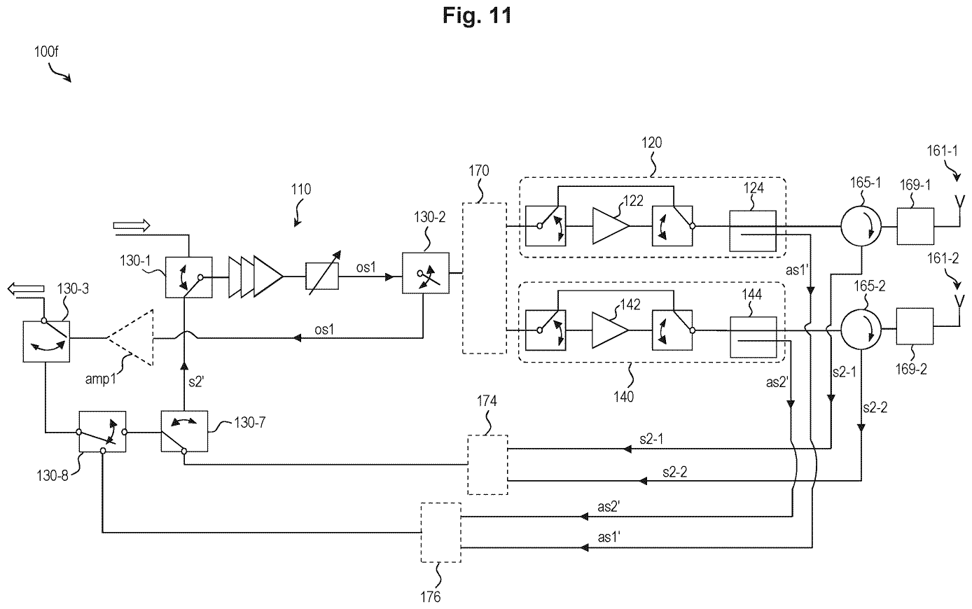

FIG. 11 schematically depicts an apparatus 100f according to further exemplary embodiments, which is similar to the apparatus 100e of FIG. 10. However, instead of the switches 130-8, 130-9 and the combiner 172 as depicted by FIG. 10, the apparatus 100e of FIG. 10 comprises two combiners 174, 176 and a switch 130-8.

In some exemplary embodiments, the combiner 174 is configured to combine the signals s2-1, s2-2. In some exemplary embodiments, the combiner 176 is configured to combine the signals as1′, as2′.

In some exemplary embodiments, the switch 130-7 is configured to selectively provide an output signal of the combiner 174 to the first amplifier stage 110 or to the switch 130-8.

In some exemplary embodiments, the switch 130-8 is configured to selectively provide an output signal of the switch 130-7 or of the combiner 176 to the third switch 130-3.

In some exemplary embodiments, by providing the combiners 174, 176, the switches 130-8, 130-9 may be omitted.

In some exemplary embodiments, using the apparatus 100f, received signals s2-1, s2-2 may directly be provided to the third switch 130-3, e.g. via the switches 130-7, 130-8, or may be provided via the first amplifier stage 110 and the optional amplifier amp1 to the third switch 130-3.

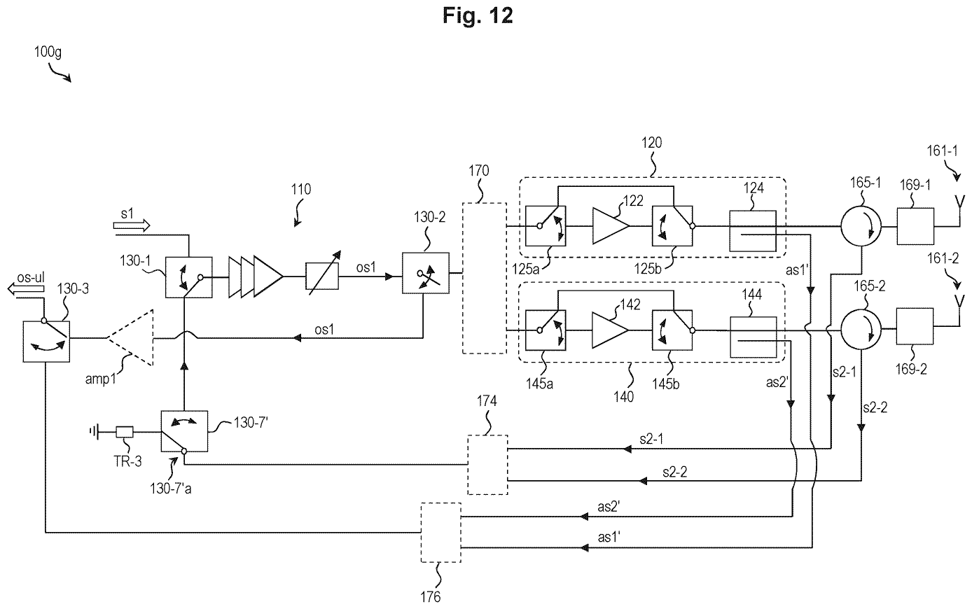

FIG. 12 schematically depicts an apparatus 100g according to further exemplary embodiments, which is similar to the apparatus 100f of FIG. 11. The switch 130-7′ can optionally couple its input port 130-7′a with a termination resistor TR-3, which may be beneficial, e.g. based on an isolation level as provided by the first switch 130-1.

In some exemplary embodiments, using the apparatus 100g of FIG. 12, the signals as1′ and as2′ may e.g. be directly connected to the switch 130-3. By this embodiment variant, e.g. switch 130-8 as exemplarily depicted by FIG. 11 can be omitted.

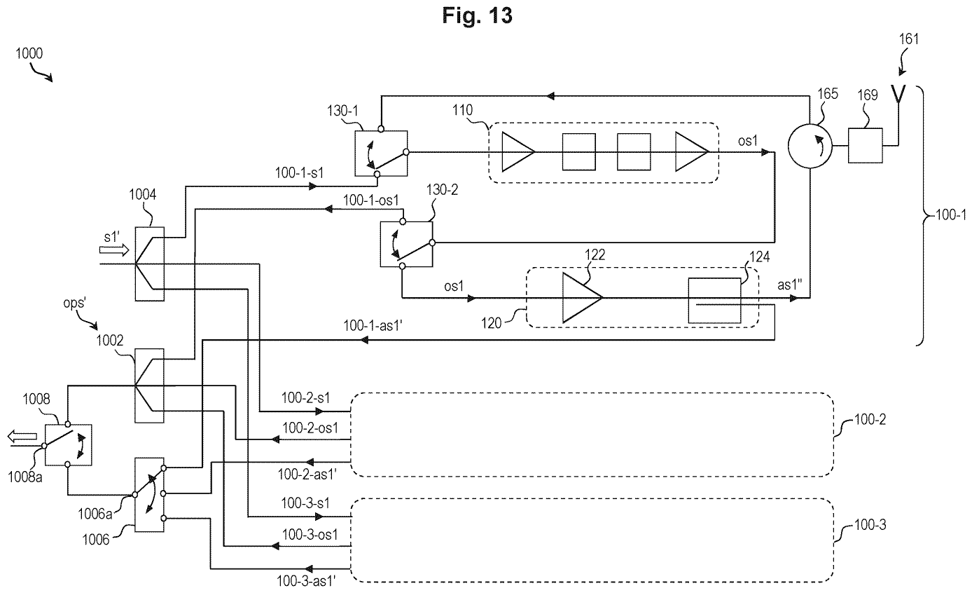

Further exemplary embodiments, FIG. 13, relate to a system 1000 for processing radio frequency signals, comprising a first apparatus 100-1 according to the embodiments and at least one further (presently two further) apparatus(es) 100-2, 100-3 according to the embodiments, wherein a common output processing stage ops′ is provided for the first apparatus 100-1 and the at least one further apparatus 100-2, 100-3. In some exemplary embodiments, by providing the first apparatus 100-1 and the at least one further apparatus 100-2, 100-3, higher transmit powers and/or an increased flexibility can be attained, e.g. when using the system 1000 for providing signal(s) to be transmitted.

In some exemplary embodiments, e.g. analogue beamforming, e.g. for sub-array elements, can be achieved, e.g. using phase shifters and/or controllable attenuators.

In some exemplary embodiments, at least one of the apparatuses 100-1, 100-2, 100-3 may e.g. comprise the configuration of FIG. 5 (or similar), with the exception that the common output processing stage ops′ is provided in the system 1000 of FIG. 13, e.g. instead of individual third switches 130-3 (see, for example, FIG. 5).

In some exemplary embodiments, FIG. 13, the common output processing stage ops′ comprises a first combiner 1002 configured to combine respective output signals 100-1-os1, 100-2-os1, 100-3-os1 of the first amplifier stage 110 of the first apparatus 100-1 and the at least one further apparatus 100-2, 100-3.

In some exemplary embodiments, FIG. 13, the system 1000 comprises a splitter 1004 configured to provide a respective first signal 100-1-s1, 100-2-s1, 100-3-s1 to a respective first amplifier stage 110 of the first apparatus 100-1 and the at least one further apparatus 100-2, 100-3. This way, respective portions of a same first signal, e.g. input signal s1′, can be provided to the respective first amplifier stages of the system 1000.

In some exemplary embodiments, FIG. 13, the system 1000 comprises a first switch 1006 for selectively providing the portion 100-1-as1′, 100-2-as1′, 100-3-as1′ of the amplified signal of the first apparatus 100-1 or of the at least one further apparatus 100-2, 100-3 at an output of the first switch 1006.

In some exemplary embodiments, FIG. 13, the system 1000 comprises a second switch 1008 for selectively providing an output signal of the common output processing stage ops′ or an output signal of the first switch 1006 at an output 1008a of the second switch 1008.

In some exemplary embodiments, the system 1000 can e.g. be used for a hybrid multi-antenna system.

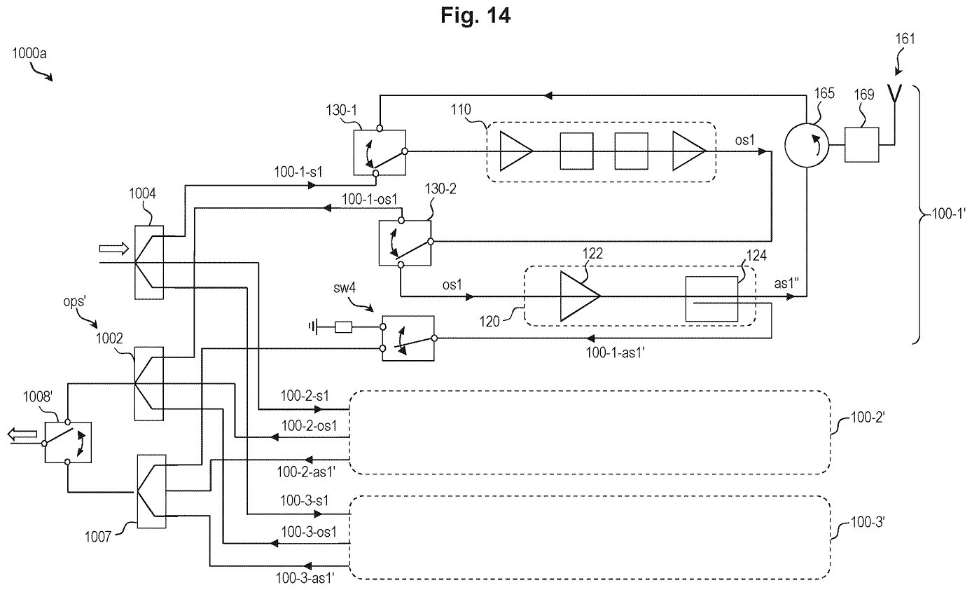

In some exemplary embodiments, see FIG. 14, the system 1000a comprises a second combiner 1007 configured to combine respective output signals of the couplers of the first apparatus 100-1′ and the at least one further apparatus 100-2′, 100-3′.

As can be seen from FIG. 14, the apparatuses 100-1′, 100-2′, 100-3′ comprise a structure similar to the apparatuses 100-1, 100-2, 100-3 of FIG. 13, wherein at least some, for example all, apparatuses 100-1′, 100-2′, 100-3′ comprise a respective switch sw4 (only indicated for apparatus 100-1′ of FIG. 14, for reasons of clarity) configured to selectively couple an input configured to receive an output from the coupler 124 to a termination resistor or the second combiner 1007.

In some exemplary embodiments, at least some of the switches used within the system 1000a can e.g. be configured as a Single Pole Double Throw (SPDT) switch.

In some exemplary embodiments, the system 1000a comprises a third switch 1008′ for selectively providing an output signal of the common output processing stage ops′ or an output signal of the second combiner 1007 at an output of the third switch 1008′.

In some exemplary embodiments, the system 1000a of FIG. 14 can flexibly select one or more feedback paths, e.g. from one or more of the apparatuses 100-1′, 100-2′, 100-3′.

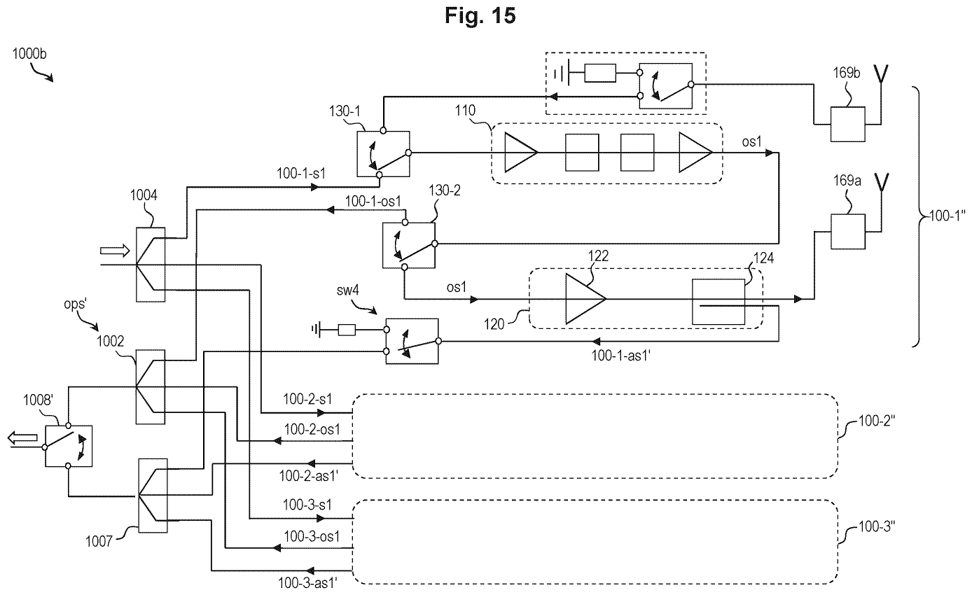

FIG. 15 schematically depicts a block diagram of a system 1000b according to further exemplary embodiments, wherein the apparatuses 100-1″, 100-2″, 100-3″ are provided, which, in some exemplary embodiments may e.g. be at least similar to the apparatus 100c of FIG. 7, e.g. comprising separate antennas each for a transmit direction and a receive direction.

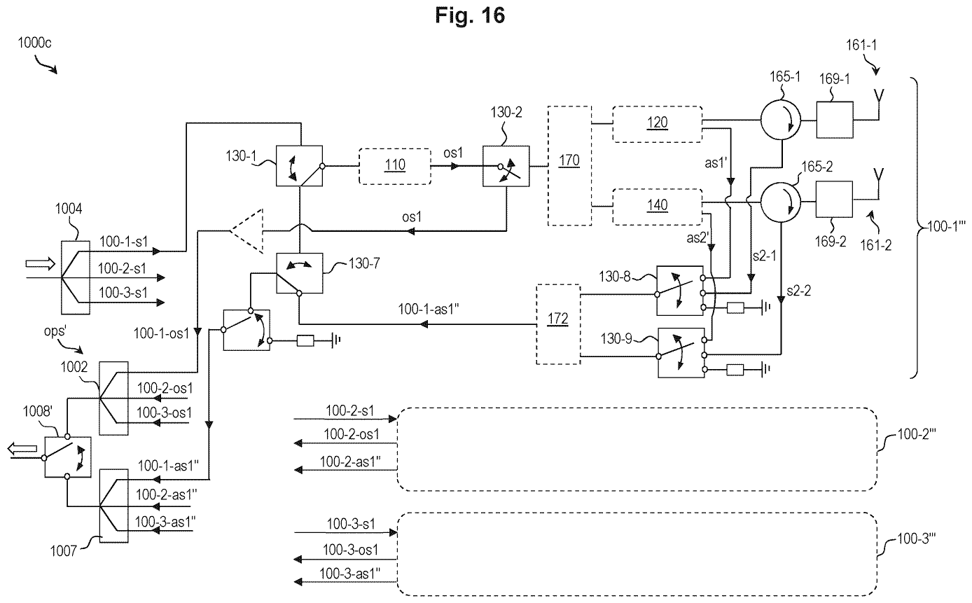

FIG. 16 schematically depicts a block diagram of a system 1000c according to further exemplary embodiments, wherein the apparatuses 100-1′″, 100-2′″, 100-3′″ are provided, which, in some exemplary embodiments may e.g. be at least similar to the apparatus 100d of FIG. 8 or 100e of FIG. 10, e.g. comprising multiple, presently for example two, other amplifier stages 120, 140 than the first amplifier stage 110 (e.g., LNA amplifier stage), the amplifier stages 120, 140 e.g. being associated with a respective frequency band fb-1, fb-2, see also FIG. 9.

In some exemplary embodiments, using three-pole switches with a third pole e.g. being terminated, e.g. by a termination resistor, e.g. comprising 50 Ohm, allows not only for selection of which antenna element is fed back, e.g. for linearization, but also selection if in this case both or only one of the frequency bands are fed back for linearization. In other words, in some exemplary embodiments, it is e.g. possible to, e.g. only, feed back a signal of frequency band fb-1 of an upper antenna element (e.g., fb-2 terminated for feedback) and e.g. to fed back a signal of frequency band fb-2 of a lower antenna path. In some exemplary embodiments, other combinations of either single signal or overlaid (several antenna paths and/or frequency bands simultaneously) feedback are possible.

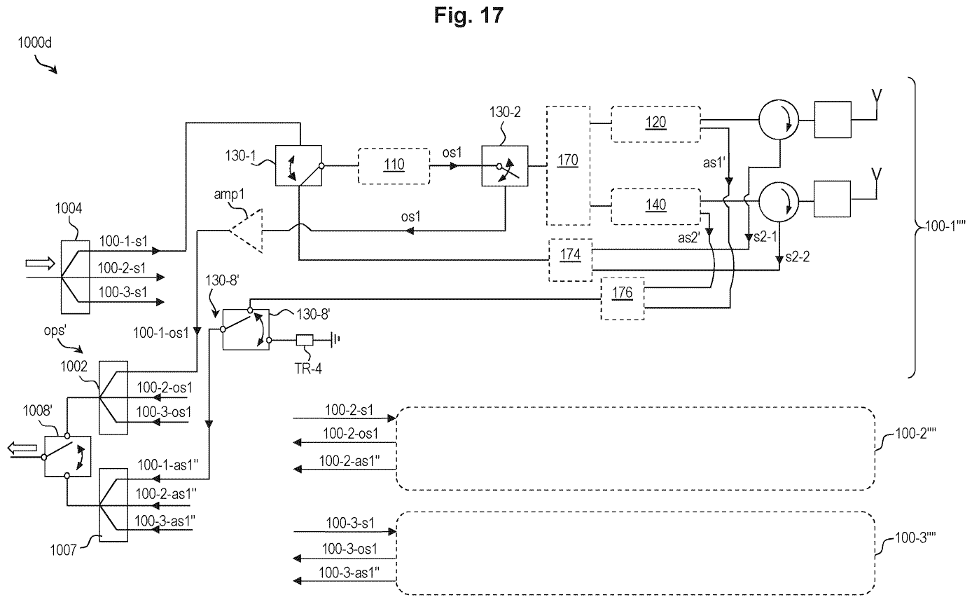

FIG. 17 schematically depicts a block diagram of a system 1000d according to further exemplary embodiments, wherein the apparatuses 100-1″, 100-2″, 100-3″ are provided, which, in some exemplary embodiments may e.g. be at least similar to the apparatus 100f of FIG. 11 or the apparatus 100g of FIG. 12, e.g. comprising multiple, presently for example two, other amplifier stages 120, 140 than the first amplifier stage 110 (e.g., LNA amplifier stage), the amplifier stages 120, 140 e.g. being associated with a respective frequency band fb-1, fb-2, see also FIG. 9. As can be seen from FIG. 17, in some exemplary embodiments, the system 1000d may use less switches than e.g. the system 1000c of FIG. 16 (e.g., by using combiners, e.g. diplexers), thus e.g. enabling to reduce a control effort associated with switches, reducing a complexity, and reducing costs.

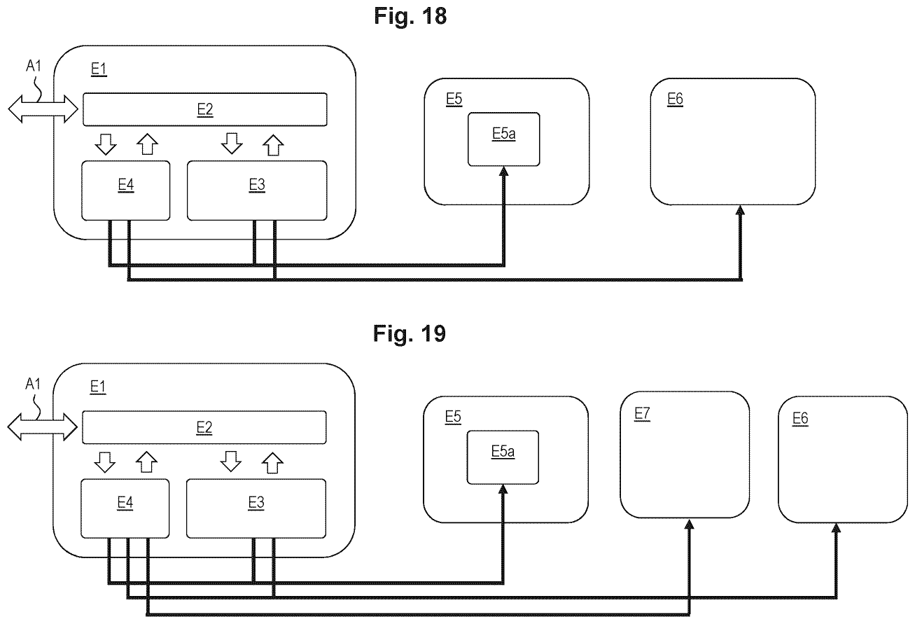

FIG. 18 schematically depicts a simplified block diagram according to further exemplary embodiments, which is related to aspects of operating at least one of an apparatus and a system according to the embodiments. As an example, the aspects exemplarily depicted by FIG. 18 can e.g. be used to control an operation of the apparatus 100g of FIG. 12.

Element E1 symbolizes a digital frontend comprising a, for example central, control unit E2. Element E3 symbolizes aspects related to a regular operation, e.g. for at least one of transmission of, e.g. downlink, signals and processing received, e.g. uplink, signals. Element E4 symbolizes aspects related to an optional linearization, e.g. using at least one of the signal portions as1′, as2′ (FIG. 12) as provided by the respective couplers 124, 144. Element E5 symbolizes aspects e.g. related to at least one of a feedback operation and a receive operation, e.g. controlling the third switch 130-3 (FIG. 12).

Element E6 symbolizes aspects e.g. related to at least one of a transmit operation and a receive operation, e.g. controlling at least one of the switches 130-1, 130-2, 125a, 125b, 145a, 145b, 130-7′ (FIG. 12).

Block arrow A1 symbolizes an optional coordination with at least one further entity (not shown), e.g. baseband processing unit or the like.

In some exemplary embodiments, e.g. for a transmit operation, the digital frontend E1 may control at least some of the switches of the apparatus 100g of FIG. 12 as follows: control the first switch 130-1 to provide the first signal s1 to the first amplifier stage 110, control the second switch 130-2 to provide the output signal os1 to the coupling device 170. In some exemplary embodiments, the optional bypass switches 125a, 125b, 145a, 145b may be controlled to bypass one of the amplifiers 122, 142. In some exemplary embodiments, a state of the switches 130-3, 130-7′ is not important for the exemplary transmit operation.

In some exemplary embodiments, e.g. for a receive operation, the digital frontend E1 may control at least some of the switches of the apparatus 100g of FIG. 12 as follows: control the first switch 130-1 to provide the output signal of the switch 130-7′ to the first amplifier stage 110, control the second switch 130-2 to provide the output signal os1 to the third switch 130-3, e.g. via the optional amplifier amp1, control the third switch 130-3 to provide the (amplified) output signal os1 as an, e.g. uplink, output signal os-ul. In some exemplary embodiments, a state of the optional bypass switches 125a, 125b, 145a, 145b is not important for the exemplary receive operation. Also, as an example, the amplifiers 122, 142 may be deactivated for the exemplary receive operation.

In some exemplary embodiments, e.g. for a linearization operation associated with at least one of the amplifiers, e.g. power amplifiers, 122, 142, the digital frontend E1 may control at least some of the switches of the apparatus 100g of FIG. 12 as follows: control the first switch 130-1 to provide the first signal s1 to the first amplifier stage 110, control the second switch 130-2 to provide the output signal os1 to the coupling device 170. In some exemplary embodiments, the optional bypass switches 125a, 125b, 145a, 145b may be controlled to bypass one of the amplifiers 122, 142 (e.g., for performing linearization for a specific one of the (power) amplifiers 122, 142), control the switch 130-7′ to connect its input port 130-7′a to the termination resistor TR-3, control the third switch 130-3 to connect the feedback path from the combiner 176 to an output of the third switch 130-3.

In some exemplary embodiments, e.g. for a linearization operation associated with the first amplifier stage 110, the digital frontend E1 may control at least some of the switches of the apparatus 100g of FIG. 12 as follows: control the first switch 130-1 to provide the first signal s1 to the first amplifier stage 110, control the second switch 130-2 to provide the output signal os1 to the third switch 130-3 (e.g., via the optional amplifier amp1), control the switch 130-7′ to connect its input port 130-7′ a to the termination resistor TR-3, control the third switch 130-3 to connect the feedback path from the second switch 130-2 (or the optional amplifier amp1) to the output of the third switch 130-3.

FIG. 19 schematically depicts a simplified block diagram according to further exemplary embodiments, which is related to aspects of operating at least one of an apparatus and a system according to the embodiments. As an example, the aspects exemplarily depicted by FIG. 19 can e.g. be used to control an operation of the system 1000d of FIG. 17.

Elements E1, E2, E3, E4, E5, E6 of FIG. 19 correspond to elements E1, E2, E3, E4, E5, E6 of FIG. 18. Element E7 of FIG. 19 symbolizes aspects e.g. related to at least one of a feedback operation, e.g. controlling the switch 1008′ of the system 1000d of FIG. 17.

In some exemplary embodiments, e.g. for a transmit operation, the digital frontend E1 may control at least some of the switches of the system 1000d of FIG. 17 as follows: control the respective first switch 130-1 of at least one apparatus 100-1″, for example of all apparatuses 100-1″, 100-2″, 100-3″, to provide the first signal s1, e.g. as provided by the splitter 1004, to the respective first amplifier stage 110, control the respective second switch 130-2 of at least one apparatus 100-1″, for example of all apparatuses 100-1″, 100-2″, 100-3″, to provide the output signal os1 to the coupling device 170, control the respective switch 130-8 to connect its output port 130-8a to the termination resistor TR-4. In some exemplary embodiments, the optional bypass switches 125a, 125b, 145a, 145b may be controlled to bypass one of the amplifiers 122, 142. In some exemplary embodiments, a state of the switch 1008′ may not important for the exemplary transmit operation, but, in some exemplary embodiments a state of the switch 1008′ may be important, e.g. if during a downlink operation a linearization is to be applied.

In some exemplary embodiments, FIG. 19, e.g. for a receive operation, the digital frontend E1 may control at least some of the switches of the system 1000d of FIG. 17 as follows: control the first switch 130-1 of at least one apparatus 100-1″, for example of all apparatuses 100-1″, 100-2″, 100-3″, to provide the output signal of the combiner 174 to the respective first amplifier stage 110, control the second switch 130-2 of at least one apparatus 100-1″, for example of all apparatuses 100-1″, 100-2″, 100-3″, to provide the output signal os1 to the combiner 1002, e.g. via the respective optional amplifier amp1, control the switch 130-8 to connect its output port 130-8a to the respective termination resistor TR-4, connect the switch 1008′ to the output port of the combiner 1002.

In some exemplary embodiments, FIG. 19, e.g. for a linearization operation associated with at least one of the amplifiers, e.g. power amplifiers, 122, 142, the digital frontend E1 may control at least some of the switches of the system 1000d of FIG. 17 as follows: control the first switch 130-1 of at least one apparatus 100-1″, for example of all apparatuses 100-1″, 100-2″, 100-3″, to provide the first signal s1 to the first amplifier stage 110, control the second switch 130-2 of at least one apparatus 100-1″, for example of all apparatuses 100-1″, 100-2″, 100-3″, to provide the output signal os1 to the respective coupling device 170. In some exemplary embodiments, the optional bypass switches 125a, 125b, 145a, 145b may be controlled to bypass one of the amplifiers 122, 142 (e.g., for performing linearization for a specific one of the (power) amplifiers 122, 142), control the switch 130-8 to connect its output port 130-8a to the output of the combiner 176, control the switch 1008′ to connect the feedback path from the combiner 176 via 1007 to an output of the switch 1008′. In some exemplary embodiments, e.g. for a linearization operation associated with the first amplifier stage 110, the digital frontend E1 may control at least some of the switches of the system 100d of FIG. 17 as follows: control the first switch 130-1 of at least one apparatus 100-1″, for example of all apparatuses 100-1″, 100-2″, 100-3″, to provide the first signal s1 to the first amplifier stage 110, control the second switch 130-2 of at least one apparatus 100-1″, for example of all apparatuses 100-1″, 100-2″, 100-3″, to provide the output signal os1 to the combiner 1002 (e.g., via the optional amplifier amp1).

In some exemplary embodiments, e.g. for an alternative linearization operation associated with the first amplifier stage 110, the digital frontend E1 may control at least some of the switches of the system 100d of FIG. 17 as follows: control the first switch 130-1 of at least one apparatus 100-1″, for example of all apparatuses 100-1″, 100-2″, 100-3″, to provide the first signal s1 to the first amplifier stage 110, control the second switch 130-2 of at least one apparatus 100-1″, for example of all apparatuses 100-1″, 100-2″, 100-3″, to provide the output signal os1 to the coupling device 170, control the bypass switches 125a, 125b, 145a, 145b to bypass the amplifiers 122, 142, control the switch 130-8 of at least one apparatus 100-1″ to connect its output port 130-8a to the output of the combiner 176, optionally control the switch(es) 130-8 of at least one further apparatus 100-2″, 100-3″ to connect its output port 130-8a to the termination resistor TR-4, control the switch 1008′ to connect the feedback path from the combiner 1007/the switch(es) 130-8 to an output of the switch 1008′.

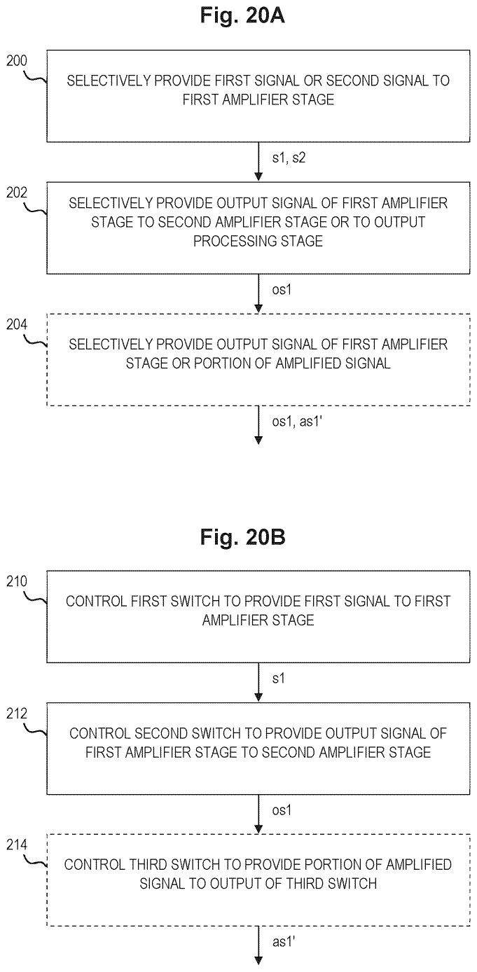

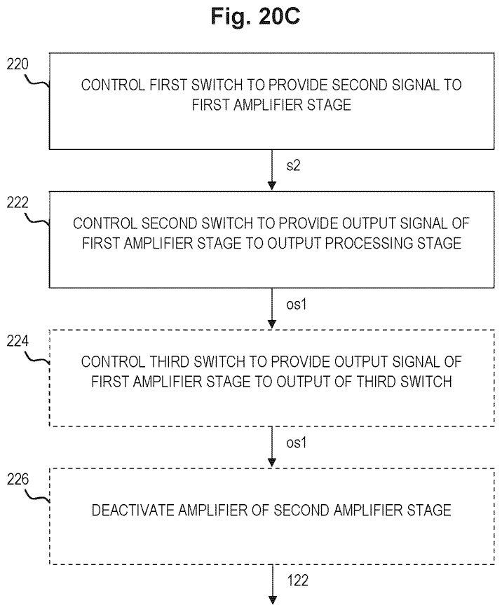

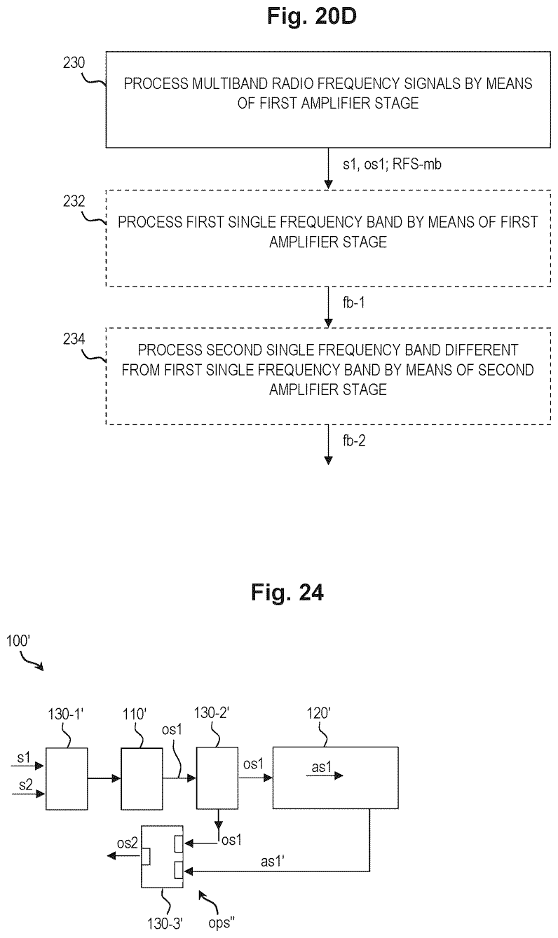

Further exemplary embodiments, FIG. 20A, relate to a method of operating an apparatus for processing radio frequency signals, the apparatus comprising a first amplifier stage 110 (FIG. 5), a second amplifier stage 120, a first switch 130-1, a second switch 130-2, and an output processing stage ops, the method comprising: selectively providing 200, by means of the first switch, a first signal s1 or a second signal s2 to the first amplifier stage 110, selectively providing 202, by means of the second switch, an output signal os1 of the first amplifier stage 110 to the second amplifier stage 120 or to the output processing stage ops, wherein the second amplifier stage 120 comprises an amplifier 122 configured to amplify the output signal os1 as provided by the second switch 130-2 to the second amplifier stage 120 to obtain an amplified signal, wherein the second amplifier stage 120 comprises a coupler 124 configured to provide a portion as1′ of the amplified signal to the output processing stage ops.

In some exemplary embodiments, the output processing stage ops comprises a third switch 130-3, wherein the method comprises: selectively providing 204, by means of the third switch 130-3, a) the output signal os1 of the first amplifier stage 110 as provided by the second switch 130-2 to the third switch 130-3 or b) the portion as1′ of the amplified signal at an output of the third switch 130-3.

In some exemplary embodiments, FIG. 20B, the method comprises: controlling 210 the first switch 130-1 to provide the first signal s1 to the first amplifier stage 110, controlling 212 the second switch 130-2 to provide the output signal os1 of the first amplifier stage 110 to the second amplifier stage 120.

In some exemplary embodiments, FIG. 20B, the method comprises: controlling 214 the third switch 130-2 to provide the portion as1′ of the amplified signal to an output of the third switch 130-3.

In some exemplary embodiments, FIG. 20C, the method comprises: controlling 220 the first switch 130-1 to provide the second signal s2 to the first amplifier stage 110, controlling 222 the second switch 130-2 to provide the output signal os1 of the first amplifier stage 110 to the output processing stage ops.

In some exemplary embodiments, FIG. 20C, the output processing stage ops comprises a or the third switch 130-3, and the method comprises: controlling 224 the third switch 130-3 to provide the output signal os1 of the first amplifier stage 110 to an output of the third switch 130-3.

In some exemplary embodiments, FIG. 20C, the method comprises: deactivating 226 the amplifier 122 of the second amplifier stage 120.

In some exemplary embodiments, FIG. 20D, the method comprises: processing 230, by means of the first amplifier stage 110, multiband radio frequency signals RFS-mb (FIG. 9) comprising at least a first frequency band fb-1 and a second frequency band fb-2.

In some exemplary embodiments, FIG. 20D, the method comprises: processing 232, by the second amplifier stage 120, a first single frequency band fb-1 of the at least first frequency band or second frequency band.

In some exemplary embodiments, FIG. 20D, the method comprises: processing 234, by a third amplifier stage 140, a second single frequency band fb-2 of the at least first frequency band or second frequency band, wherein the second single frequency band fb-2 is different from the first single frequency band fb-1.

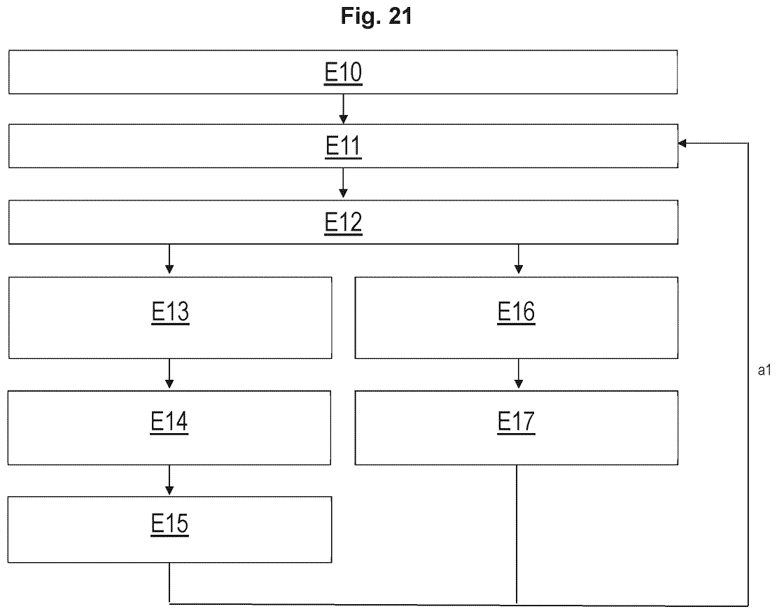

FIG. 21 schematically depicts a simplified flow-chart according to exemplary embodiments. Element E10 symbolizes a start of a regular operation of at least one of an apparatus or a system according to exemplary embodiments. Element E11 symbolizes a configuration of switches of the apparatus or system, e.g. to a predetermined initialization state. Element E12 symbolizes an exemplary uplink operation, e.g. associated with receiving at least one signal via at least one antenna 161.

Elements E13, E14, E15 symbolize aspects of an exemplary downlink transmission operation, e.g. associated with transmitting at least one signal via the at least one antenna 161. Element E13 symbolizes configuring of the switches of the apparatus or system for downlink with linearization (for exemplary details, see FIG. 18 or 19). Element E14 symbolizes a downlink transmission operation of the apparatus or system with measurement of feedback signals as e.g. provided by at least one coupler 124 (FIG. 5). Element E15 of FIG. 21 symbolizes a linearization processing which may e.g. comprise at least one of calculating, updating and applying linearization parameters, e.g. based on the measurement of feedback signals of Element E14.

Elements E16, E17 symbolize aspects of an alternative exemplary downlink transmission operation, e.g. associated with transmitting at least one signal via the at least one antenna 161, however, without linearization. Element E16 symbolizes configuring of the switches of the apparatus or system for downlink without linearization (for exemplary details, see FIG. 18 or 19). Element E17 symbolizes a downlink transmission operation of the apparatus or system without measurement of feedback signals.

In some exemplary embodiments, after element E15 or E17, the procedure may continue, see arrow a1 of FIG. 21, with element E11.

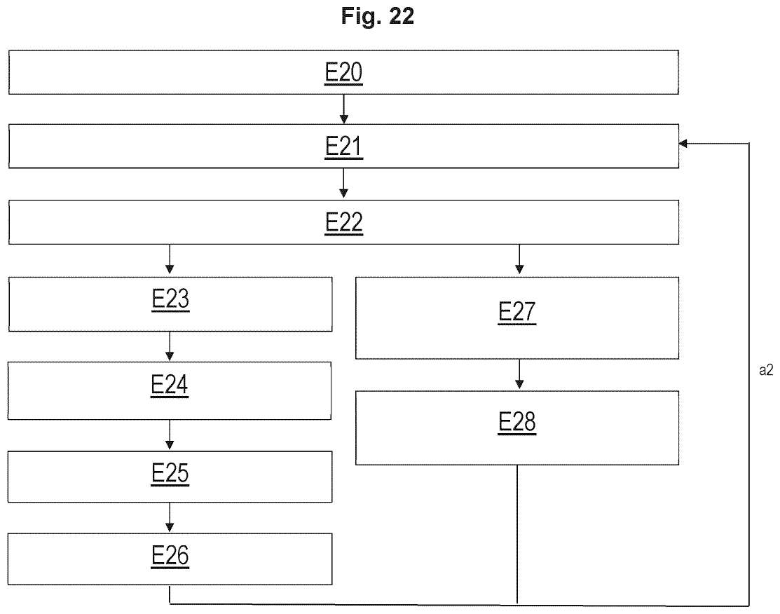

FIG. 22 schematically depicts a simplified flow-chart according to exemplary embodiments.

Element E20 symbolizes a start of a regular operation of at least one of an apparatus or a system according to exemplary embodiments. Element E21 symbolizes a configuration of switches of the apparatus or system, e.g. to a predetermined initialization state, e.g. for an uplink operation. Element E22 symbolizes an exemplary uplink operation, e.g. associated with receiving at least one signal via at least one antenna 161.

Elements E23, E24, E25, E26 symbolize aspects of an exemplary downlink transmission operation, e.g. associated with transmitting at least one signal via the at least one antenna 161. Element E23 symbolizes configuring of the switches of the apparatus or system for downlink with linearization (for exemplary details, see FIG. 18 or 19). Element E24 symbolizes a downlink transmission operation of the apparatus or system with measurement of feedback signals as e.g. provided by at least one coupler 124 (FIG. 5). Element E25 of FIG. 22 symbolizes a selection which amplifiers are to be linearized, e.g. using switch 130-8 of FIG. 18 (the other amplifiers'associated signals may e.g. be terminated by switch(es) 130-8). Element E26 of FIG. 22 symbolizes a linearization processing which may e.g. comprise at least one of calculating, updating and applying linearization parameters, e.g. based on the measurement of feedback signals of Element E24.

Elements E27, E28 of FIG. 22 symbolize aspects of an alternative exemplary downlink transmission operation, e.g. associated with transmitting at least one signal via the at least one antenna 161, however, without linearization. Element E27 symbolizes configuring of the switches of the apparatus or system for downlink without linearization (for exemplary details, see FIG. 18 or 19). Element E28 symbolizes a downlink transmission operation of the apparatus or system without measurement of feedback signals.

In some exemplary embodiments, after element E26 or E28, the procedure may continue, see arrow a2 of FIG. 22, with element E21.

In some exemplary embodiments, using the approach of FIG. 22, specific amplifiers, e.g. power amplifiers, and/or antenna paths can selectively be linearized (e.g., using a respective downlink signal associated with the specific amplifier(s) to be fed back), e.g. by controlling switch 130-8. In some exemplary embodiments, amplifiers, e.g. power amplifiers, and/or antenna paths not to be linearized at a given point in time can be terminated by switch(es) 130-8 of the respective apparatus(es).

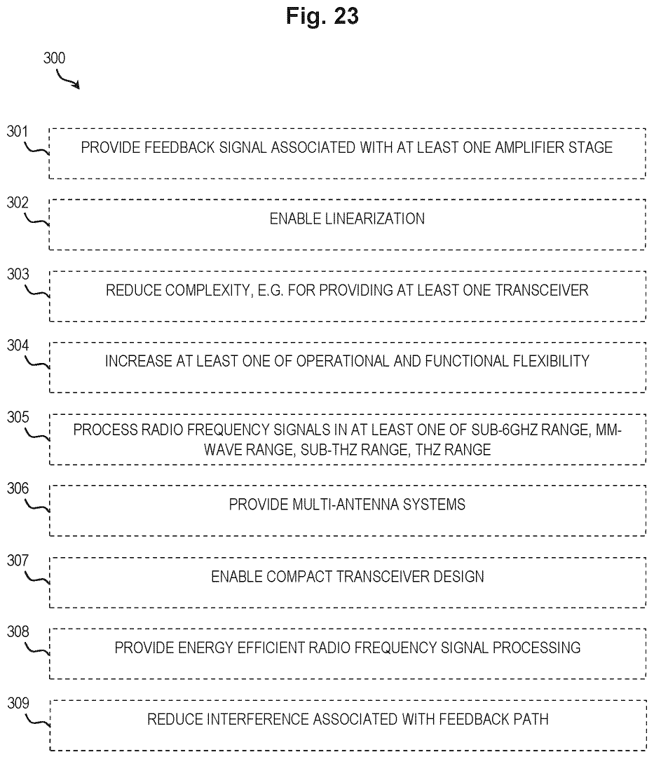

Further exemplary embodiments, FIG. 23, relate to a use 300 of at least one of the apparatus 100, 100a, 100b, 100c, 100d, 100e, 100f, 100g, 100′ according to embodiments, the system according to the embodiments, the method according to the embodiments for at least one of: a) provide 301 at least one feedback signal associated with at least one amplifier stage, b) enable 302 a linearization, c) reduce 303 complexity, e.g. for providing at least one transceiver, d) increase 304 at least one of an operational and functional flexibility, e) process 305 radio frequency signals, e.g. in at least one of a sub-6 GHz frequency range, a mm-wave frequency range, a sub-THz frequency range, a THz frequency range, f) provide 306 multi-antenna systems, e.g., fully digital or hybrid multi-antenna systems, e.g. for beamforming, e.g. for massive MIMO, g) enable 307 a compact transceiver design (e.g., by selectively processing both transmit and receive signals using the first amplifier stage 110), h) provide 308 energy efficient radio frequency signal processing, i) reduce 309 interference associated with a feedback path.

Further exemplary embodiments, FIG. 24, relate to an apparatus 100′ for processing radio frequency signals, comprising first amplifier means 110′, second amplifier means 120′, first switch means 130-1′ configured to selectively provide a first signal s1 or a second signal s2 to the first amplifier means 110′, second switch means 130-2′ configured to selectively provide an output signal os1 of the first amplifier means 110′ to the second amplifier means 120′ or to output processing means ops″, wherein the second amplifier means 120′ are configured to amplify the output signal os1 as provided by the second switch means 130-2′ to the second amplifier means 120′ to obtain an amplified signal as1, wherein the second amplifier means 120′ are further configured to provide a portion as1′ of the amplified signal as1 to the output processing means ops″.

The principle according to the embodiments enables to attain an increased operational and functional flexibility, e.g. when using the apparatus or the system according to the embodiments to provide a transceiver, e.g. for a base station of a wireless communications network. As an example, e.g. for a downlink operation, e.g. using the principle according to the embodiments to process signals to be transmitted via at least one antenna, an operation both with feedback signal measurement or without feedback signal measurement is possible.

In some exemplary embodiments, different kinds of downlink path configurations are possible, e.g. with respect to the amplifiers, e.g. power amplifiers, 122, 142, see, for example, FIG. 8.: a) power amplifiers 122, 142 for both frequency bands fb-1, fb-2 active, b) power amplifier 122 for one of the frequency bands (e.g., frequency band fb-1) active, while the other power amplifier 142 (e.g., for the other frequency band fb-2) is bypassed, c) both power amplifiers 122, 142 being bypassed. As an example, e.g. in case of both power amplifiers 122, 142 bypassed, and if a linearization feedback signal measurement and a linearization is active, the first amplifier stage 110 can be linearized. In some exemplary embodiments, this configuration can e.g. be used for lower load situations, enabling to reduce power consumption in case of low load situations. In other words, in some exemplary embodiments, the power amplifiers 122, 142 may be bypassed, and the output signal os1 as provided by the first amplifier stage 110 can be provided to the at least one antenna.

In some exemplary embodiments, the abovementioned configuration can e.g. be especially beneficial for multi-antenna applications where, for example, a lot of closely spaced, adjacent antennas are implemented, e.g. causing unwanted interfering signals, e.g. to the wanted feedback signals.

The principle according to the embodiments can e.g. be used to implement at least one coupler 124 (FIGS. 1, 5) into a common transceiver (TRX) architecture e.g. comprising at least one apparatus according to the embodiments, e.g. in order to avoid unwanted interferences of either external received signals or reflections caused by mismatches e.g. between a circulator 165 (FIG. 5) and a filter 169 or the filter 169 and the at least one antenna 161.

In some exemplary embodiments, the proposed implementation of the feedback coupler 124 can e.g. be applied to different common TRX architectures/variants, such as e.g. common TRX, high power common TRX, multiband common TRX, as well as for their implementation into multi-antenna systems, e.g. frontends.

In some exemplary embodiments, the coupler 124 may comprise a coupling structure for radio frequency signals comprising a designed, e.g. conductor, e.g. transmission line, structure, e.g. provided on a support member, e.g. carrier, e.g. RF carrier board.

In some exemplary embodiments, providing or adding switches, e.g. to at least one feedback path, e.g. with one port terminated using a termination resistor (e.g. 50 Ohm) allows for flexible selection which of the respective signal paths, e.g. antenna/common transceiver paths, are selected, e.g. for actual linearization. In some examples, this can be useful e.g. for hybrid-multi-antenna system based applications and especially for multiband common TRX based hybrid multi-antenna systems, since for the latter one, this exemplary approach allows not only to select specific antenna path(s) for linearization, but also to additionally select which frequency band(s) are actually used for linearization.

In some exemplary embodiments, at least one of the abovementioned specific antenna path(s) can be additionally flexibly used, e.g. for calibration measurements, e.g. up to an output of the power amplifier 122, 142.

In some exemplary embodiments, the configuration of FIG. 6 using a switch 167 to couple the output of the second amplifier stage 120 with the at least one antenna 161, e.g. via the filter 169, can e.g. be beneficial for mm-wave applications.

The principle according to the embodiments enables to provide comparatively compact transceiver architectures, e.g. supporting linearization, e.g. with comparatively high feedback path performance and additionally with high flexibility of which signals (antenna paths, frequency bands fb-1, fb-2) are actually to be fed back and used for linearization, which can e.g. be flexibly reconfigured. some exemplary embodiments, FIGS. 1, 5, an output signal as1′ of the coupler 124 can e.g. be used for calibration measurements, e.g. up to the power amplifier output. some exemplary embodiments, a signal processing chain, e.g. from the output of the power amplifier 122 to the least one antenna 161, may e.g. be calibrated separately, e.g. via an over-the-air method.

1. An apparatus for processing radio frequency signals, comprising:
a first amplifier stage,
a second amplifier stage,
a first switch,
second switch, and
an output processing stage, wherein
the first switch is configured to selectively provide a first signal or a second signal to the first amplifier stage,
the second switch is configured to selectively provide an output signal of the first amplifier stage to the second amplifier stage or to the output processing stage,
the second amplifier stage comprises an amplifier configured to amplify the output signal as provided by the second switch to the second amplifier stage to obtain an amplified signal, and
the second amplifier stage comprises a coupler configured to provide a portion of the amplified signal to the output processing stage.

2. The apparatus according to claim 1, wherein the output processing stage comprises:
a third switch configured to selectively provide a) the output signal of the first amplifier stage as provided by the second switch to the third switch or b) the portion of the amplified signal at an output of the third switch.

3. The apparatus according to claim 1, wherein the amplifier of the second amplifier stage is a power amplifier.

4. The apparatus according to claim 1, wherein the first amplifier stage comprises at least one of the following: a) a first amplifier, b) a filter, c) an attenuator d) a second amplifier, e) a phase shifter.

5. The apparatus according to claim 1, wherein the apparatus, in a first operating mode (M), is configured to control the first switch to provide the first signal to the first amplifier stage, to control the second switch to provide the output signal of the first amplifier stage to the second amplifier stage.

6. The apparatus according to claim 5, wherein the apparatus, the first operating mode, is configured to control the third switch to provide the portion of the amplified signal to an output of the third switch.

7. The apparatus according to claim 1, wherein the apparatus, a second operating mode, is configured to control the first switch to provide the second signal to the first amplifier stage, to control the second switch to provide the output signal of the first amplifier stage to the third switch.

8. The apparatus according to claim 7, wherein the apparatus, in the second operating mode, is configured to control the third switch to provide the output signal of the first amplifier stage to the output of the third switch.

9. The apparatus according to claim 7, wherein the apparatus, in the second operating mode, is configured to deactivate the amplifier of the second amplifier stage.

10. The apparatus according to claim 1, comprising:
at least one antenna configured to a) transmit a signal provided by the second amplifier stage and/or to b) receive the second signal and provide the second signal to the first switch.

11. The apparatus according to claim 10, comprising at least one of the following elements for coupling at least one of the second amplifier stage or the first switch with the at least one antenna; a) a circulator, b) a switch, c) a filter.

12. The apparatus according to claim 1, comprising:
a fourth switch configured to selectively couple at least one component of the apparatus with a termination resistor.

13. The apparatus according to claim 1, comprising:
a third amplifier stage, the third amplifier stage comprising an amplifier configured to amplify a signal provided to an input port of the third amplifier stage, and
a coupler configured to provide a portion of an amplified signal obtained by the amplifier to the third switch.

14. The apparatus according to claim 13, wherein an output port of the second switch is coupled with respective input ports of the second amplifier stage and the third amplifier stage by a coupling device.

15. The apparatus according to claim 14, wherein the coupling device comprises at least one of: a) a switch, b) a diplexer.

16. The apparatus according to claim 13, wherein the first amplifier stage is configured to process multiband radio frequency signals comprising at least a first frequency band and a second frequency band, wherein the second amplifier stage is configured to process a single frequency band of the at least first frequency band or second frequency band.

17. The apparatus according to claim 13, comprising:
a combiner,
a switch configured to selectively provide the portion of the amplified signal associated with the second amplifier stage or a further signal to a first input port of the combiner, and
a switch configured to selectively provide the portion of the amplified signal associated with the third amplifier stage or a further signal to a second input port of the combiner.

18. The apparatus according to claim 13, comprising:
a combiner configured to combine the portion of the amplified signal associated with the second amplifier stage with the portion of the amplified signal associated with the third amplifier stage.

19. The apparatus according to claim 13, wherein at least one of the second amplifier stage and the third amplifier stage comprises bypass switches configured to selectively bypass a respective amplifier of the second amplifier stage and the third amplifier stage.

20-27. (canceled)

28. Method of operating an apparatus for processing radio frequency signals, the apparatus comprising a first amplifier stage, a second amplifier stage, a first switch, a second switch, and an output processing stage, the method comprising:
selectively providing, by the first switch, a first signal or a second signal to the first amplifier stage,
selectively providing, by the second switch, an output signal of the first amplifier stage to the second amplifier stage or to the output processing stage, wherein
the second amplifier stage comprises an amplifier configured to amplify the output signal as provided by the second switch to the second amplifier stage to obtain an amplified signal, and
the second amplifier stage comprises a coupler configured to provide a portion of the amplified signal to the output processing stage.

29.-37. (canceled)
